(19) United States
(12) Patent Application Publication
(10) Pub. No.: US 2020/0189447 A1
(43) Pub. Date: Jun. 18, 2020

(54) GUILLOTINE-STYLE HEADLIGHT DIMMER SWITCHING DEVICE

(71) Applicant: TOPOWER CO., LTD., TAINAN CITY (TW)

(72) Inventors: CHUN-HSIANG HSU, TAINAN CITY (TW); SHIH-CHI LIN, TAINAN CITY (TW)

(21) Appl. No.: 16/217,259

(22) Filed: Dec. 12, 2018

(51) Int. Cl. B60Q 1/14; F21S 41/692; F21S 41/47

(52) U.S. Cl. CPC B60Q 1/1438; F21S 41/47; F21S 41/692

(57) ABSTRACT

A guillotine-style headlight dimmer switching device includes: a light socket having a reflecting surface, wherein a front edge of the reflecting surface has a fixing portion, the fixing portion having an opening; a light source disposed on the reflecting surface; a light-blocking plate pivotally connected to the fixing portion and having a first board and a second board, the second board normally blocking the opening, the first board having a push plate protruding; and a solenoid valve fixed to the fixing portion and having a push rod capable of moving by extension and retraction, the push rod having a push element, wherein the push element of the push rod moving by extension and retraction moves along a pushing path, the push plate being located at the pushing path, so as to cut manufacturing costs, render assembly simple and quick, reduce total volume of the headlight, thereby achieving miniaturization.

### BACKGROUND OF THE INVENTION

### 1. Technical Field

The present disclosure relates to a compact headlight structure for switching between high and low beam headlights cheaply and quickly.

### 2. Description of Related Art

Conventional headlights of vehicles are capable of switching between a high beam and a low beam in order to accommodate to different driving environments.

There are conventional headlight switching devices. For instance, a headlight dimmer switching device, disclosed in Taiwan patent M361443 filed on Jul. 21, 2009, comprises: a reflecting mirror, a fixed light-blocking plate, a movable light-blocking plate, a solenoid valve and a connecting rod. The front edge of the reflecting mirror extends outward to form a connecting surface which a convex mirror stand is mounted on and a securing base which the solenoid valve is disposed on. The fixed light-blocking plate and the movable light-blocking plate are sequentially disposed in front of the connecting surface of the reflecting mirror. The movable light-blocking plate is a two-segment structure. The first segment is connected to an acting axle of the solenoid valve through the connecting rod. The second segment is transversely disposed in front of the reflecting mirror. The junction of the first segment and the second segment is pivotally connected to the front of the fixed light-blocking plate by a pivot. Hence, as soon as the acting axle of the solenoid valve protrudes outward or retracts inward, the connecting rod drives the second segment of the movable light-blocking plate to swing downward or upward, causing the lighting mode of the headlight to switch between a high beam and a low beam. Therefore, the headlight module can be more compact and more practicable, whereas the service life of the solenoid valve can be extended.

However, the patent requires the fixed light-blocking plate and thus incurs high manufacturing costs and renders assembly complicated. Furthermore, the patent requires the connecting rod for adjusting the control over and switching between the high and low beam headlights; as a result, the connecting rod requires more movement-related space, and thus the headlight becomes more bulky (i.e., cannot be miniaturized). Moreover, the connecting rod is connected between the movable light-blocking plate and the acting axle of the solenoid valve; hence, their operation consumes more power in order for the solenoid valve to drive the connecting rod and the movable light-blocking plate. As a result, after long use, the junction of the connecting rod, the movable light-blocking plate, and the acting axle of the solenoid valve is likely to jam, whereas heat is radiated to the solenoid valve and thus leads to component expansion or increased heat accumulation; hence, the components are predisposed to aging and elastic fatigue, thereby ending up with a shortened service life.

A headlight dimmer switching device for a headlight, disclosed in Taiwan patent M565146 filed on Aug. 11, 2018, comprises: a fixing plate and a valve holder, the valve holder being fixedly disposed on one side of the fixing plate, wherein a positioning post is disposed on the fixing plate and on each of two sides of an opening, and outer end of the positioning post has a blocking edge, with a light-blocking plate disposed on a lateral surface of the fixing plate. One side of the light-blocking plate extends and bends to form a connecting plate. The connecting plate is disposed at a valve rod of the valve holder. A positioning blocking plate is disposed at each of the two ends of the light-blocking plate. The positioning blocking plate corresponds in position to the positioning post of the fixing plate so as to be blocked and hold by the positioning post and the blocking edge. Hence, the headlight dimmer switching device consists of a few simple components and can be assembled easily and quickly, thereby incurring low costs.

The headlight dimmer switching device uses a solenoid valve to drive the light-blocking plate directly, so as to adjust the control over and switch between the high and low beam headlights. Although the headlight dimmer switching device does not have the aforesaid drawbacks of the prior art, that is, using the connecting rod to effectuate connection and thus increasing the required movement space, the headlight dimmer switching device still requires a fixing plate and thus disadvantageously incurs high manufacturing costs and renders assembly complicated. As a result, the headlight dimmer switching device is unsatisfactory.

### BRIEF SUMMARY OF THE INVENTION

As mentioned before, the headlight dimmer switching device for a headlight has the aforesaid drawbacks.

Therefore, the present disclosure provides a guillotine-style headlight dimmer switching device, comprising: a light socket having a reflecting surface, wherein a front edge of the reflecting surface has a fixing portion; the fixing portion having an opening; a light source disposed on the reflecting surface; a light-blocking plate pivotally connected to the fixing portion and having a first board and a second board, the second board normally blocking the opening, the first board having a push plate protruding; and a solenoid valve fixed to the fixing portion and having a push rod capable of moving by extension and retraction, the push rod having a push element, the push element being normally not in contact with the push plate, wherein the push element of the push rod moving by extension and retraction moves along a pushing path, the push plate being located at the pushing path.

The fixing portion is disposed near a front edge of the reflecting surface.

The opening is disposed above the fixing portion.

A light beam emitted from the light source and then reflected by the reflecting surface passes the second board from above to form a low beam.

The push element pushes the push plate so that the second board is driven by the first board to rotate and thus no longer blocks the opening, thereby allowing a light beam emitted from the light source and reflected by the reflecting surface to pass through the opening, so as to form a high beam.

The first board and the second board are perpendicular to each other. An end portion of the second board is confined to a limiting element on the fixing portion.

A pivotal end is disposed between the first board and the second board. The pivotal end is pivotally connected to the fixing portion and has a torsional spring for exerting a torsional force under which the second board normally blocks the opening.

The torsional spring has a first end and a second end. The first end is positioned at a positioning element on the fixing portion. The second end is positioned on the push plate.

The guillotine-style headlight dimmer switching device further comprises a lampshade fixed to the fixing portion.

The guillotine-style headlight dimmer switching device has advantages as follows:

1. Since the light socket has the fixing portion disposed near a front edge of the reflecting surface, and the fixing portion has the opening, thereby dispensing with a conventional fixed light-blocking plate or fixing plate. Hence, the guillotine-style headlight dimmer switching device reduces manufacturing costs and renders assembly simple and quick.

2. Since the push rod of the solenoid valve directly pushes the push plate of the light-blocking plate so that the second board no longer blocks the opening, and thus the total volume of the headlight assembled is reduced, thereby achieving miniaturization.

3. When the solenoid valve is not operating, the push element is separated from the push plate of the light-blocking plate, so as to prevent heat from being directly transferred from the light-blocking plate to the solenoid valve. When the solenoid valve is operating, the push element pushes the light-blocking plate away from the opening; meanwhile, the light-blocking plate can escape from the focus of thermal radiation of the light source; hence, heat otherwise accumulated on the light-blocking plate and transferred to the solenoid valve is greatly reduced, thereby reducing structural variation otherwise induced by thermal deformation and thus extending the service life of the guillotine-style headlight dimmer switching device.

### BRIEF DESCRIPTION OF THE SEVERAL VIEWS OF THE DRAWINGS

FIG. 1 is a perspective view of an embodiment of the present disclosure;

FIG. 2 is a cutaway view of the embodiment of the present disclosure;

FIG. 3 is a schematic view of the embodiment of the present disclosure, showing a light-blocking plate for normally blocking an opening;

FIG. 4 is a schematic view of the embodiment of the present disclosure, showing a light beam passing a second board from above to form a low beam;

FIG. 5 is a schematic view of the embodiment of the present disclosure, showing that the light-blocking plate no longer blocks the opening; and

FIG. 6 is a schematic view of the embodiment of the present disclosure, showing a light beam passing through an opening to form a high beam.

### DETAILED DESCRIPTION OF THE INVENTION

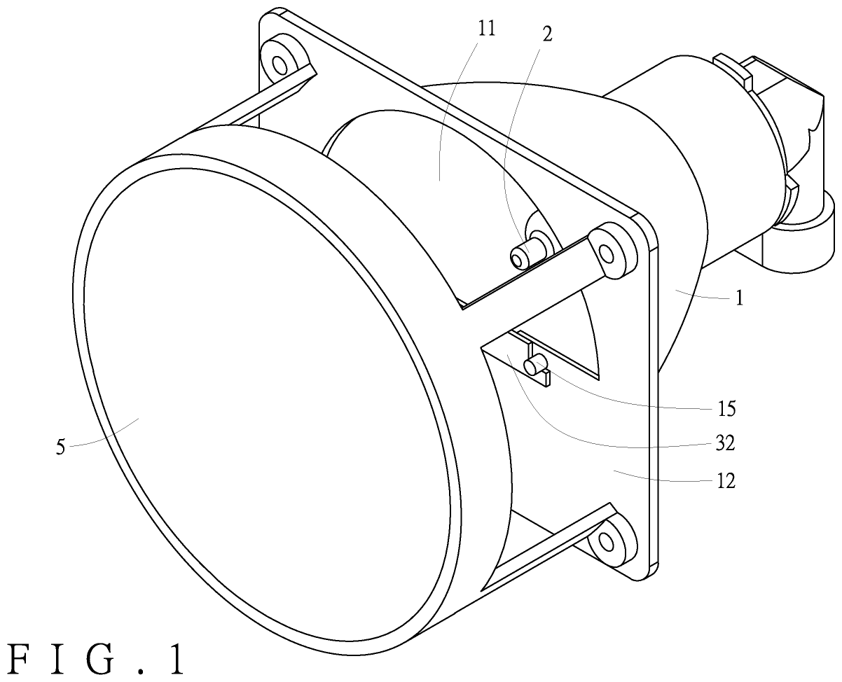

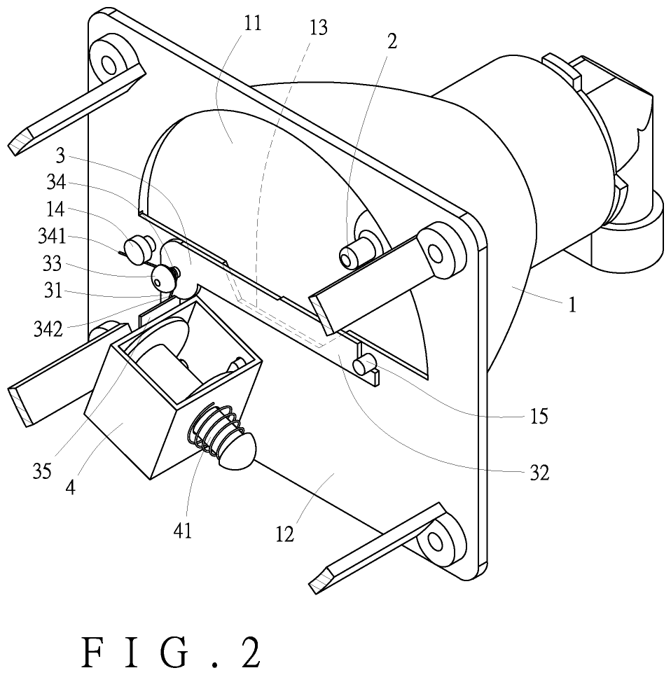

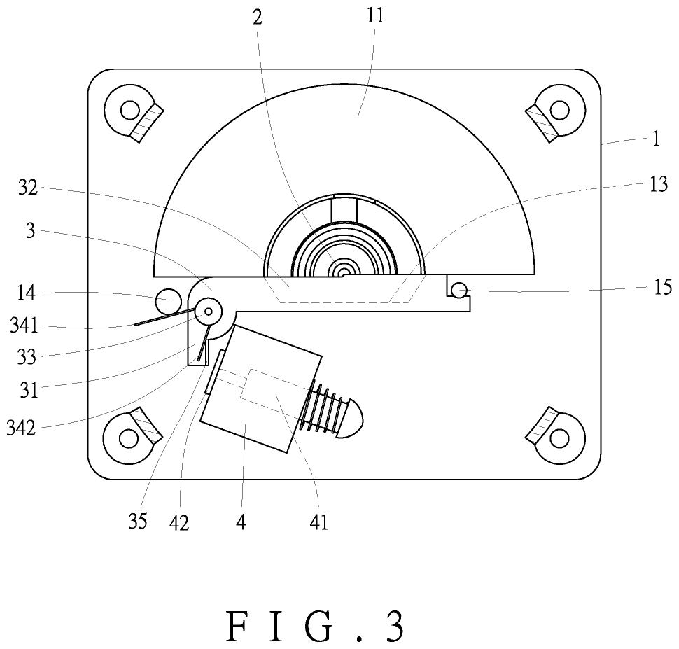

Referring to FIG. 1, FIG. 2 and FIG. 3, a guillotine-style headlight dimmer switching device provided in an embodiment of the present disclosure comprises a light socket (1), a light source (2), a light-blocking plate (3), a solenoid valve (4) and a lampshade (5).

The light socket (1) curves inward and thus has a reflecting surface (11). The light socket (1) has a fixing portion (12) near a front edge of the reflecting surface (11). The fixing portion (12) has an opening (13). The opening (13) is flanked by a positioning element (14) and a limiting element (15).

The light source (2) is disposed on the reflecting surface (11). The light source (2) emits a light beam which falls on and then reflects off the reflecting surface (11) so that the light beam passes through the opening (13) to form a high beam.

The light-blocking plate (3) is pivotally connected to the light socket (1). The light-blocking plate (3) has a first board (31) and a second board (32) which are perpendicular to each other. A pivotal end (33) is disposed between the first board (31) and the second board (32). The pivotal end (33) is pivotally connected to the fixing portion (12), so as to form a guillotine-style structure. The pivotal end (33) has a torsional spring (34). The torsional spring (34) has a first end (341) and a second end (342). The first end (341) is positioned at the positioning element (14) on the fixing portion (12). Under the torsional force exerted by the torsional spring (34), the second board (32) normally blocks the opening (13). The light beam emitted from the light source (2) and then reflected by the reflecting surface (11) passes the second board (32) from above to form a low beam. A push plate (35) is protrudingly disposed on the first board (31). The second end (342) of the torsional spring (34) is positioned on the push plate (35). An end portion of the second board (32) is confined to the limiting element (15) on the fixing portion (12) to prevent the second board (32) from going beyond the height of the fixing portion (12).

The solenoid valve (4) is fixed to the fixing portion (12) of the light socket (1). The solenoid valve (4) has a push rod (41) capable of moving by extension and retraction when electrically powered. An end portion of the push rod (41) has a push element (42). Normally, the push element (42) is not in contact with the push plate (35) of the light-blocking plate (3). The push element (42) of the push rod (41) moving by extension and retraction moves along a pushing path. The push plate (35) is located at the pushing path.

The lampshade (5) is fixed to the fixing portion (12) of the light socket (1).

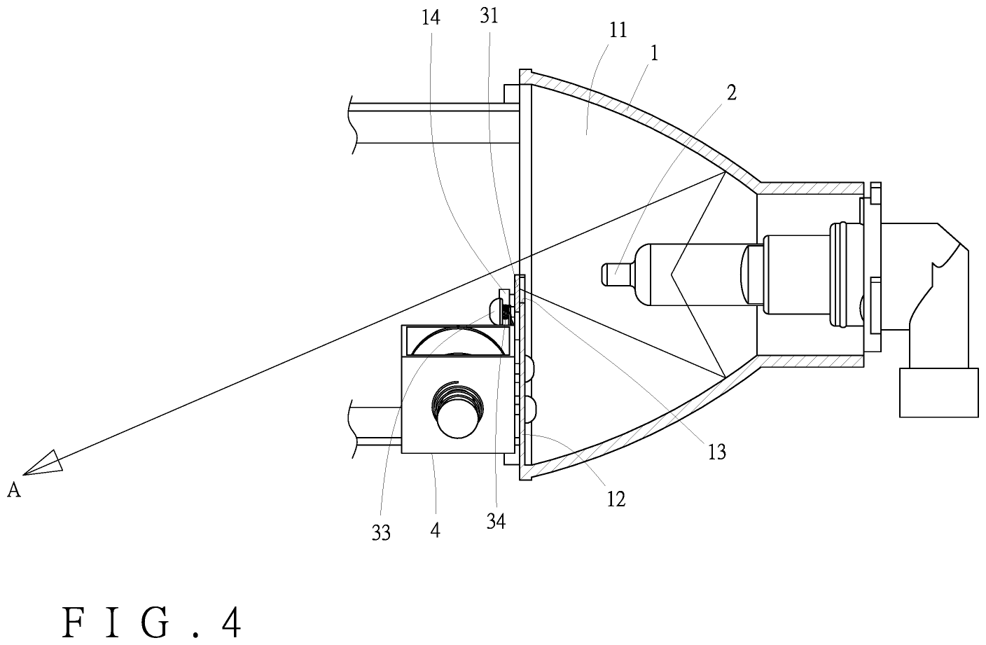

As shown in FIG. 3 and FIG. 4, a low beam is normally provided at the commencement of use, by controlling the push rod (41) of the solenoid valve (4) to retract so that the push element (42) of the push rod (41) does not come into contact with the push plate (35) on the light-blocking plate (3). Hence, the first board (31) of the light-blocking plate (3) is not subjected to any push, and thus the second board (32) can normally block the opening (13) under the torsional force exerted by the torsional spring (34). Therefore, the light beam emitted from the light source (2) can reflect off the reflecting surface (11) so that the light beam can only pass the second board (32) from above to form a low beam (A). The low beam (A) illuminates a front area a short distance away.

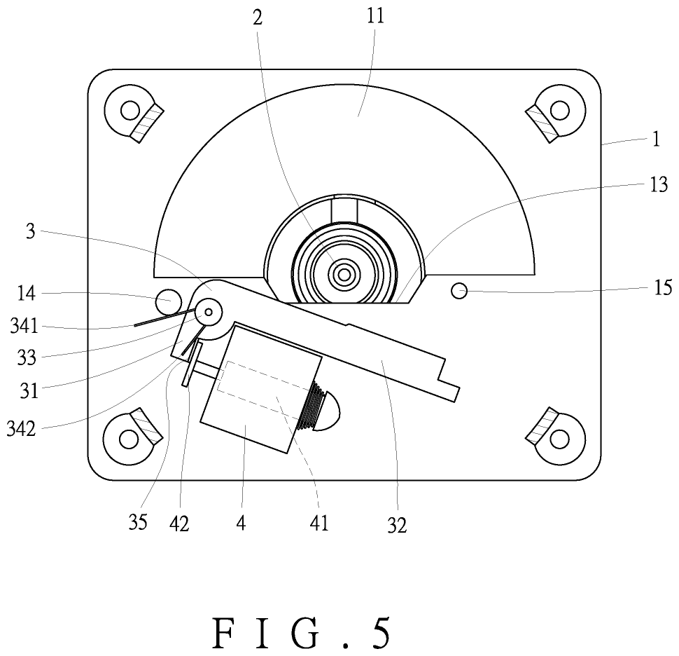

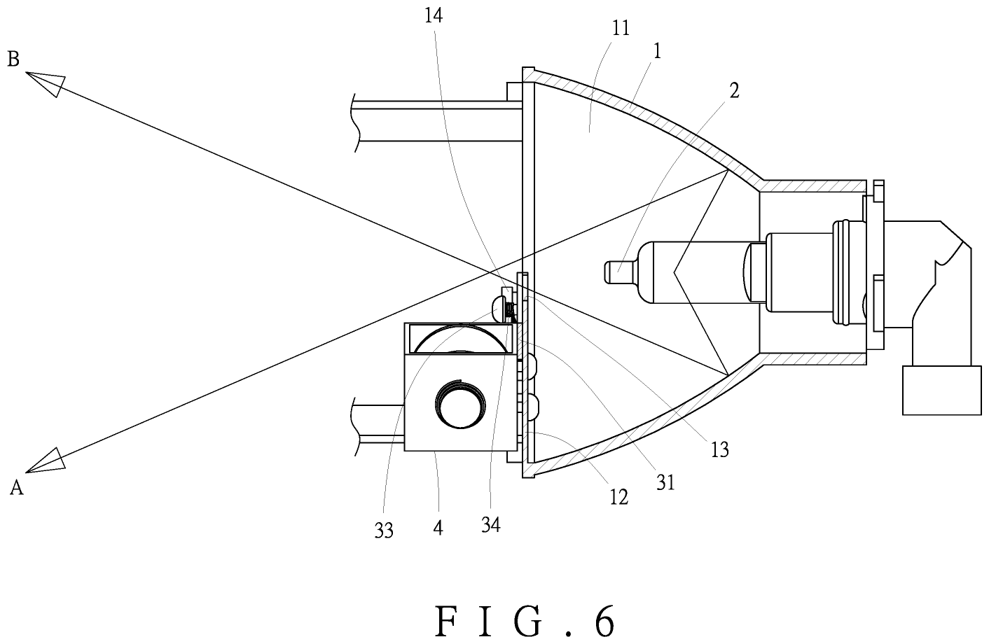

Referring to FIG. 5 and FIG. 6, to switch to a high beam, it is necessary to cause the push rod (41) of the solenoid valve (4) to extend so that the push element (42) of the push rod (41) moves along the pushing path. Since the push plate (35) of the light-blocking plate (3) is located at the pushing path, the push element (42) of the push rod (41) pushes the push plate (35) so that the first board (31) of the light-blocking plate (3) is subjected to a push; then, the second board (32) is driven by the first board (31) to rotate about the pivotal end (33), thereby compressing the torsional spring (34). Owing to its rotation, the second board (32) moves downward relative to the opening (13) and thus no longer blocks the opening (13). Therefore, in addition to the low beam (A), the light beam emitted from the light source (2) reflects off the reflecting surface (11) and then passes through the opening (13) to form a high beam (B). The high beam (B) illuminates a front area a long distance away. Furthermore, owing to the second board (32) of the light-blocking plate (3), the light-blocking plate (3) stays away from the focus of thermal radiation of the light source (2); hence, heat otherwise accumulated on the light-blocking plate (3) and transferred to the solenoid valve (4) is greatly reduced, thereby extending the service life of the guillotine-style headlight dimmer switching device.

Therefore, the present disclosure is advantageous in that the light socket (1) has the fixing portion (12) near the front edge of the reflecting surface (11), and the fixing portion (12) has the opening (13), thereby dispensing with the conventional components, such as a fixed light-blocking plate or fixing plate. Hence, the present disclosure cuts manufacturing costs and renders assembly simple and quick. The present disclosure is also advantageous in that the push rod (41) of the solenoid valve (4) directly extends and pushes the push plate (35) of the light-blocking plate (3) so that the second board (32) of the light-blocking plate (3) no longer blocks the opening (13). Therefore, the total volume of the headlight is reduced, thereby achieving miniaturization.

In conclusion, the description of the aforesaid embodiments enables persons skilled in the art to gain insight into the operation, use and advantages of the present disclosure. The present disclosure is disclosed above by preferred embodiments, but the preferred embodiments are not restrictive of the scope of implementation of the present disclosure. Hence, all simple, equivalent changes and modifications made to the aforesaid embodiments in accordance with the specifications and claims of the present disclosure shall fall within the scope of the present disclosure.

What is claimed is:

1. A guillotine-style headlight dimmer switching device, comprising:
a light socket having a reflecting surface, wherein a front edge of the reflecting surface has a fixing portion;
the fixing portion having an opening;
a light source disposed on the reflecting surface;
a light-blocking plate pivotally connected to the fixing portion and having a first board and a second board, the second board normally blocking the opening, the first board having a push plate protruding; and
a solenoid valve fixed to the fixing portion and having a push rod capable of moving by extension and retraction, the push rod having a push element, the push element being normally not in contact with the push plate, wherein the push element of the push rod moving by extension and retraction moves along a pushing path, the push plate being located at the pushing path.

2. The guillotine-style headlight dimmer switching device of claim 1, wherein the fixing portion is disposed near a front edge of the reflecting surface.

3. The guillotine-style headlight dimmer switching device of claim 1, wherein the opening is disposed above the fixing portion.

4. The guillotine-style headlight dimmer switching device of claim 1, wherein a light beam emitted from the light source and then reflected by the reflecting surface passes the second board from above to form a low beam.

5. The guillotine-style headlight dimmer switching device of claim 1, wherein the push element pushes the push plate so that the second board is driven by the first board to rotate and thus no longer blocks the opening, thereby allowing a light beam emitted from the light source and reflected by the reflecting surface to pass through the opening, so as to form a high beam.

6. The guillotine-style headlight dimmer switching device of claim 1, wherein the first board and the second board are perpendicular to each other, and an end portion of the second board is confined to a limiting element on the fixing portion.

7. The guillotine-style headlight dimmer switching device of claim 1, wherein a pivotal end is disposed between the first board and the second board, the pivotal end being pivotally connected to the fixing portion and having a torsional spring for exerting a torsional force under which the second board normally blocks the opening.

8. The guillotine-style headlight dimmer switching device of claim 7, wherein the torsional spring has a first end and a second end, the first end being positioned at a positioning element on the fixing portion, and the second end being positioned on the push plate.

9. The guillotine-style headlight dimmer switching device of claim 1, further comprising a lampshade fixed to the fixing portion.
